(19) United States
(12) Patent Application Publication
(10) Pub. No.: US 2003/0224339 A1
(43) Pub. Date: Dec. 4, 2003

(54) Method and system for presenting online courses

(76) Inventors: Manisha Jain, Palo Alto, CA (US); Jon S. McCarty, San Jose, CA (US); Lawrence M. Blair, Palo Alto, CA (US)

Correspondence Address: SAWYER LAW GROUP LLP, P O BOX 51418, PALO ALTO, CA, 94303, US

(21) Appl. No.: 10/159,157

(22) Filed: May 31, 2002

(51) Int. Cl. G09B 3/00

(52) U.S. Cl. 434/350; 434/362

(57) ABSTRACT

A method and system for presenting an electronic course to a user is disclosed. The method and system include receiving question data and at least one question format for the question data from a content author. The method and system further include storing the question data separately from the question format data. In a further embodiment of the present invention, at least one view script is provided for presenting the course to different types of client devices that require different display formats. The view script displays the question data in the specified question format and in the display format required by the type of client device accessing the course. In yet a further embodiment, the method and system include receiving a user's answer to the question from one of the client devices, processing the user's answer, and providing feedback to the user via the client device based on a user's answer.

### FIELD OF THE INVENTION

The present invention relates to methods of presenting online course materials, and more particularly to a web application for content authoring and dissemination.

### BACKGROUND OF THE INVENTION

Large enterprise organizations are often dynamic and undergo constant changes. For example, due to the enterprise's industry, the enterprise may be in a rapidly changing market where products change relatively quickly. Or because the market is dynamic, the enterprise may need to perform continual positioning activities due to competitive situations. The enterprise may also be dynamic organizationally, with employees being redeployed and acquisitions being made, and so on. Therefore, there is a need for constant need for knowledge dissemination and training.

With the advent of the Internet, training websites have been introduced for delivering online courses to trainees. The access mechanism to web-based training is typically a standard web browser, and the courses typically comprise a series of questions authored in HTML for the user to answer. Although web-based training has the advantage of not requiring the use of production personnel, web-based training does require content creators as well as technologists, such as webmasters, that take the content and post it on the web in a presentable format. There are generally two types of formats the author must contend with when displaying a course question to a user; display formats and question formats.

Display formats are typically specific to a particular type of browser-based device. For example, web browsers for PC's and laptops may require one type of HTML display format, while wireless devices may require a different display format, such as WML for WAP phones, or cHTML for i-mode phones, for instance. Question formats are the various forms that an author may choose to pose a particular question to a user. For example, the author may choose to present the question in multiple choice, fill-in the blank, or true/false format.

With the current approach to online courses, both display formats and question formats are hard coded with the question being presented. Assuming that each question in the course is written as a single HTLM document, this has the disadvantage of requiring that a different HTML document be written for each question format that a single question is to be presented in.

Another disadvantage is the effort required to make the presentation of the courses palatable to the various types of display formats for the variety of browser-based devices. In order to support the various types of client devices, custom web pages for the questions would have to be built for each specific device/browser type. That is, the online training site would need to provide web pages formatted in HTML, WML, cHTML, and so on, not only for each question, but also for each given question format needed for each question. This is both labor intensive to initially setup and difficult to maintain as changes are made to the site's data and services. It also results in duplicating the content of the same question many times.

Another problem with conventional web-based courses is that websites have limited feedback with respect to each user's progress in the course. There are also limited mechanisms for finding out which users viewed what information and for tracking each user's response to each question, regardless of which courses were taken.

Accordingly, what is needed is an improved method and system for presenting online courses. The present invention addresses such a need.

### SUMMARY OF THE INVENTION

The present invention provides a method and system for presenting an electronic course to a user. The method and system include receiving question data and at least one question format for the question data from a content author. The method and system further include storing the question data separately from the question format data. In a further embodiment of the present invention, at least one view script is provided for presenting the course to different types of client devices that require different display formats. The view script displays the question data in the specified question format and in the display format required by the type of client device accessing the course. In yet a further embodiment, the method and system include receiving a user's answer to the question from one of the client devices, processing the user's answer, and providing feedback to the user via the client device based on a user's answer.

According to the method and system disclosed herein, separating question content from formatting eliminates the need to duplicate each question to support multiple question formats and multiple display formats. In addition, the method and system provides the user with real time progress and tracking capabilities, thereby enhancing the effectiveness of the training.

### BRIEF DESCRIPTION OF THE DRAWINGS

FIG. 1 is a block diagram illustrating an online course presentation system.

FIG. 2 is a flow chart illustrating the process of presenting an electronic training course to a user of a client device in a preferred embodiment of the present invention.

### DETAILED DESCRIPTION

The present invention relates to web-based training presentation systems. The following description is presented to enable one of ordinary skill in the art to make and use the invention and is provided in the context of a patent application and its requirements. Various modifications to the preferred embodiments and the generic principles and features described herein will be readily apparent to those skilled in the art. Thus, the present invention is not intended to be limited to the embodiments shown but is to be accorded the widest scope consistent with the principles and features described herein.

The present erection provides a browser-based web application for presenting online training courses to client devices over a network. According to the present invention, question data comprising the each course is stored separately from both the optional question formats and the required display format. Consequently, there is no need to duplicate each question to support multiple question formats and multiple display formats.

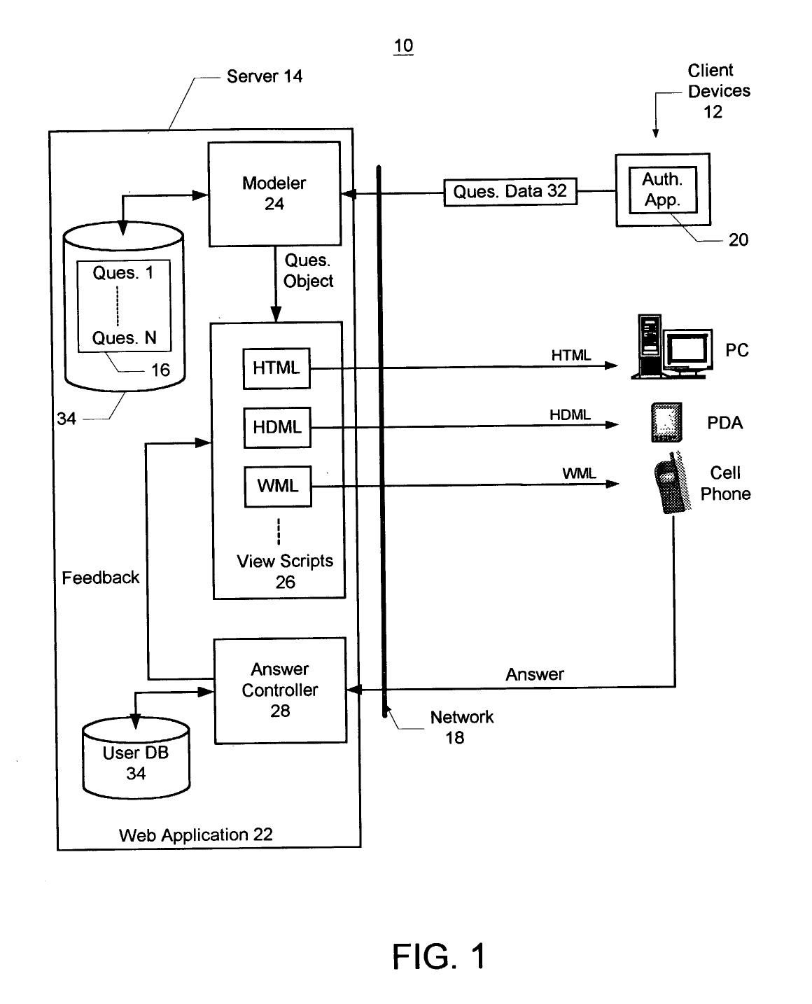

FIG. 1 is a block diagram illustrating an online course presentation system. The presentation system 10 includes a server 14 that delivers online courses 16 to users of client devices 12, which communicate with the server 14 over a network 18, such as the Internet. One or more of the client devices 12 may include an authoring application 20 that allows an author or content provider to generate an online course via a GUI and upload it to the server 14 for storage and publication.

The server 14 includes a web application 22 that has three main software components, a modeler 24, view scripts 26, and an answer controller 28. The web application 22 further includes a presentation database 30 that stores online courses 16 in the form of questions 32, and a user database 34 for maintaining statistics for each user/trainee that accesses an online course 16.

According one aspect of the present invention, the questions 32 in the presentation database 34 are stored as content, while the view scripts 26 are used to present the questions to the different types of client devices 12 in their required display format. By separating the content of each question 32 from its format, the present invention eliminates the need for the questions to be duplicated in custom web pages that are tailored for each type of client device.

A client device 12 refers to an electronic device capable of communicating with the server 14. In a preferred embodiment, the client devices 12 are browser-based, although non-browser-based devices may also be supported. Such electronic devices include PCs, PDAs, and cellphones, for example. The client devices 12 communicate over the Internet via a wireless, or wired connection, but because they incorporate different browser types, the client devices 12 communicate data in different formats. For example, some client devices 12 such as PCs may communicate data in HTML format. Other client devices 12 such as cellphones, may use display formats such as Wireless Markup Language (WML), which is a streamlined version of HTML for small screen displays, cHTML which is a subset of HTML, and Handheld Device Markup Language (HDML), for instance.

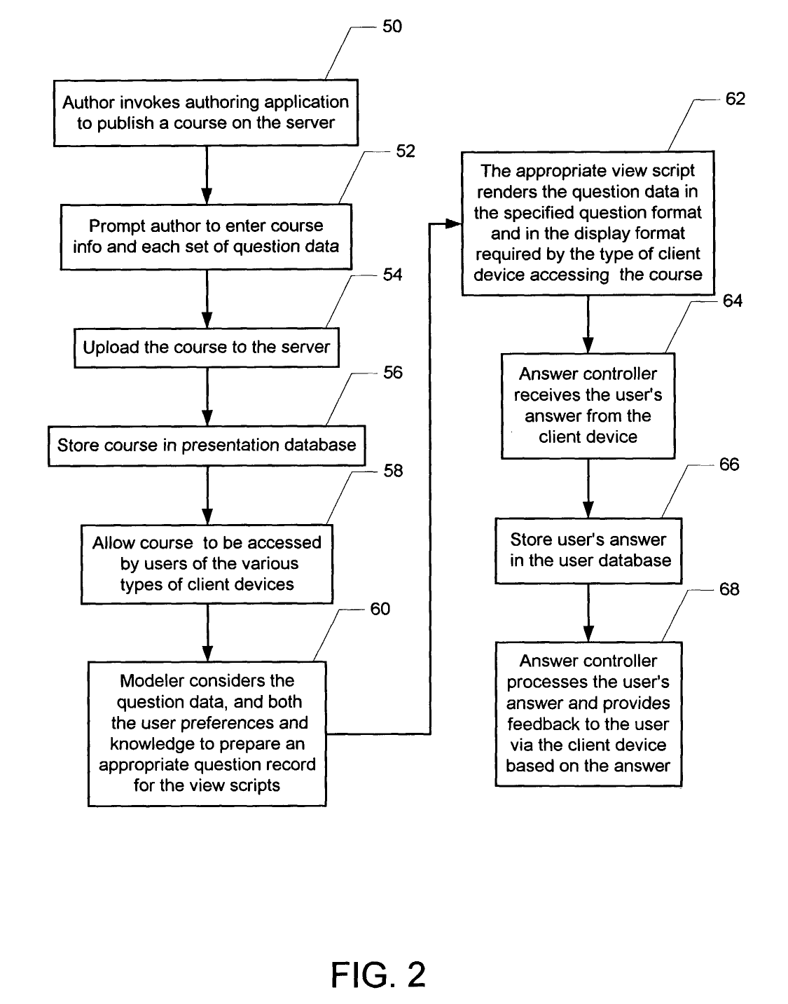

The operation of the online presentation system 10 will now be explained by way of FIG. 2, which is a flow chart illustrating the process of presenting an electronic course 16 to a user of a client device 12 in a preferred embodiment of the present invention.

The process begins in step 50 when an author or content owner invokes the authoring application 20 to publish a course 16 on the server 14. In step 52, the authoring application 20 responds by prompting the author to enter course information and each set of question data comprising the course 16. Each set of question data may include the content of the question, answer choices, and the correct answer. The author also specifies a default question format, alternative question formats, and a number of tries to give the user to choose the correct answer. In a preferred embodiment, the types of question formats may include multiple choice, true/false, fill-in the blank, an image map, scale, matching questions, and questionnaire.

According to one aspect of the present invention, the author also inputs answer rules that define the feedback the server 14 gives the user for correct and incorrect answers. The answer rules may include scores for correct and incorrect answers, and a number of consecutive correctly answered questions before the question format is switched from the default question format to one of the alternative question formats. After the user has entered all the question data 32 for the course 16, in step 54, the authoring application 20 uploads the course 16 to the server 14, preferably as an XML package.

In step 56, once the server receives the XML package, the web application 22 stores the course 16 in the presentation database 30. In a preferred embodiment, the question data 32 are stored as separate records in the presentation database 30. This enables different courses 16 to share common questions, further eliminating data duplication.

In step 58, the course 16 is published for access over the network 18 by users of the various types of client devices 12. If there are multiple courses 16 available, the user may first be shown a list of courses 16 to choose from. A user account is created for each user and the account information is stored in the user database 34 and accessed when the user logs in. In a preferred embodiment of the present invention, the account information includes user preferences and user knowledge, which includes past answer results and/or job skills.

In step 60, the modeler 24 considers the question data 32 from the presentation database 30, and both the user preferences and knowledge from the user database 34 to prepare an appropriate question record for the view scripts 26. For example, if the user's result indicate that the user has advanced skill or knowledge, then the modeler may change the question format to make the question harder. In a preferred embodiment, the questions are converted to java script objects. In step 62, the question record is passed to the view scripts 26, and the appropriate view script 26 renders the question data 32 in the specified question format and in the display format required by the type of client device 12 accessing the course. In the preferred embodiment, one view script 26 exists for each client device/browser type. However, any number of view scripts 26 may be provided. If the specified question format is fill-in the blank, then only the question content is displayed. If the specified question format is multiple choice, then both the question content and the answer choices are displayed.

In step 64, the answer controller 28 receives the user's answer from the client device 12. According to a further aspect of the present invention, the answer controller 28 in step 66 stores the user's answer for the question in the user database 34 for tracking purposes. In step 68, the answer controller 28 processes the user's answer and provides feedback to the user via the client device 12 based on the answer.

More specifically, answer controller 28 compares the user's answer with the correct answer from the question data 32 and accesses the question's answer rules to determine how to respond. If the user's answer is incorrect, the correct answer may be input to the view script for display. If the number of times the user answers the question is less than the number of permissible answer attempts specified in the question record, the answer controller 28 may instruct the view script to display the question again to give the user another chance. If the number of attempts is greater than the permissible number of attempts, the answer controller 28 may change the question format to make the question easier (e.g., from fill-in the blank to multiple choice or true/false) or simply move on to the next question.

Likewise, if the user's answer is correct, the feedback specified by the author in the case of a correct answer is input to the view script for display. If the number consecutive questions the user answered correctly exceeds the threshold set by the author, the default question format will be changed to make the next question harder.

A method and system for presenting online courses to client devices in which the question content is separated from the question and display formats has been disclosed. The present invention has been described in accordance with the embodiments shown, and one of ordinary skill in the art will readily recognize that there could be variations to the embodiments, and any variations would be within the spirit and scope of the present invention. Accordingly, many modifications may be made by one of ordinary skill in the art without departing from the spirit and scope of the appended claims.

What is claimed is:

1. A method for presenting an electronic course to a user, the method comprising the steps of:
(a) receiving question data and at least one question format for the question data from a content author; and
(b) storing the question data separately from the question format data, such that the question data does not have to be duplicated to be displayed in a different question format.

2. The method of claim 1 further including the step of:
(i) providing at least one view script for presenting the course to different types of client devices that require different display formats, wherein the view script displays the question data in the specified question format and in the display format required by the type of client device accessing the course, whereby the question data does not have to be duplicated to be displayed on each type of client device.

3. The method of claim 1 further including the steps of:
(i) receiving a user's answer to the question from one of the client devices;
(ii) processing the user's answer; and
(iii) providing feedback to the user via the client device based on the user's answer.

4. The method of claim 2 wherein the question data includes question content and a correct answer.

5. The method of claim 4 wherein the question format specifies one or more of multiple choice, true/false, fill-in the blank, and an image map.

6. The method of claim 1 wherein step (a) further includes the step of: providing a client application for receiving the question data from the content author.

7. The method of claim 6 further including the steps of: prompting the user to enter answer rules that define feedback to be provided to the user in response to receiving the user's answer to the question.

8. The method of claim 7 wherein the answer rules include scores for correct and incorrect answers, and a number of consecutive correctly answered questions before the question format is switched from the default question format to one of the alternative question formats.

9. The method of claim 1 further including the step of storing the question data as separate records in a database, and allowing different courses to share common questions.

10. The method of claim 2 wherein the view script executes on a server that is accessed by the client devices over a network.

11. The method of claim 2 wherein the display formats include or more of standard PC web browsers, and web browsers for hand-held wireless devices.

12. The method of claim 3 further including step of: providing a controller for receiving and processing the user's answer, wherein the controller executes on a server that is accessed by the client devices over a network.

13. A web-based application for presenting an online course from a server to a client device over a network, comprising:
(a) a first database for storing course content data, the content data including question content, a question answer, and a specification of a at least on question format;
(b) at least one view script for rendering the question content in the specified question format and in a display format required by the client device.

14. The web-based application of claim 13 further including an authoring application running of a computer networked to the server for receiving the content data from an author of the course, whereby the content data does not have to be re-entered to support different question formats.

15. The web-based application of claim 13 further including a controller for receiving a user's answer from the client device, and for providing feedback to the user based on the answer.

16. The web-based application of claim 13 further including a modeler for preparing content data from the first database for the view script.

17. The web-based application of claim 13 further including a user database for storing user account information, which includes user preferences and past answer results.

18. The web-based application of claim 17 wherein the past answer results are used to change the question format to make the question harder or easier for the user.

19. The web-based application of claim 18 wherein the first database further includes answer rules associated with each question.

20. The web-based application of claim 19 wherein controller compares the user's answer with the question answer from the content data and accesses the question's answer rules to determine how to respond.

21. A computer readable medium containing program instructions for presenting an electronic course to a user, the program instructions for:
(a) receiving question data and at least one question format for the question data from a content author; and
(b) storing the question data separately from the question format data, such that the question data does not have to be duplicated to be displayed in a different question format.

22. The computer readable medium of claim 21 further including the instruction of:
(i) providing at least one view script for presenting the course to different types of client devices that require different display formats, wherein the view script displays the question data in the specified question format and in the display format required by the type of client device accessing the course, whereby the question data does not have to be duplicated to be displayed on each type of client device.

23. The computer readable medium of claim 21 further including the instructions of:
(i) receiving a user's answer to the question from one of the client devices;
(ii) processing the user's answer; and
(iii) providing feedback to the user via the client device based on the user's answer.

24. The computer readable medium of claim 22 wherein the question data includes question content and a correct answer.

25. The computer readable medium of claim 24 wherein the question format specifies one or more of multiple choice, true/false, fill-in the blank, and an image map.

26. The computer readable medium of claim 21 wherein instruction (a) further includes the instruction of: providing a client application for receiving the question data from the content author.

27. The computer readable medium of claim 26 further including the instructions of: prompting the user to enter answer rules that define feedback to be provided to the user in response to receiving the user's answer to the question.

28. The computer readable medium of claim 27 wherein the answer rules include scores for correct and incorrect answers, and a number of consecutive correctly answered questions before the question format is switched from the default question format to one of the alternative question formats.

29. The computer readable medium of claim 21 further including the instruction of storing the question data as separate records in a database, and allowing different courses to share common questions.

30. The computer readable medium of claim 22 wherein the view script executes on a server that is accessed by the client devices over a network.

31. The computer readable medium of claim 22 wherein the display formats include or more of standard PC web browsers, and web browsers for hand-held wireless devices.

32. The computer readable medium of claim 23 further including instruction of: providing a controller for receiving and processing the user's answer, wherein the controller executes on a server that is accessed by the client devices over a network.
